(19) United States
(12) Patent Application Publication
(10) Pub. No.: US 2005/0239946 A1
(43) Pub. Date: Oct. 27, 2005

(54) Preparation of tire composition having improved silica reinforcement

(75) Inventors: Chenchy Jeffrey Lin, Hudson, OH (US); Terrence E. Hogan, Akron, OH (US); William Hergenrother, Akron, OH (US)

Correspondence Address: Chief IP Counsel;BRIDGESTONE AMERICAS HOLDING, INC., 1200 Firestone Parkway, Akron, OH, 44317, US

(73) Assignee: Bridgestone Corporation

(21) Appl. No.: 11/115,876

(22) Filed: Apr. 27, 2005

Related U.S. Application Data
(60) Provisional application No. 60/565,647, filed on Apr. 27, 2004.

(51) Int. Cl. C08K 3/34

(52) U.S. Cl. 524/492

(57) ABSTRACT

A vulcanizable elastomeric composition having improved filler dispersion, and comprising elastomer, silica, silica coupling agent and free water.

This application claims the benefit of U.S. Provisional Application No. 60/565,647, filed Apr. 27, 2004.

### FIELD OF THE INVENTION

This invention relates to a vulcanizable elastomeric composition having improved reinforcement.

### BACKGROUND OF THE INVENTION

Inorganic fillers, such as silica, impart improved wet traction, rolling resistance, tear strength, snow traction and other performance parameters when used as filler within tire treads. Mixing silica into a tire stock, however, is difficult because silica particles agglomerate extensively and therefore they are not easily dispersed. In addition, silica particles are less compatible than carbon black with polymers used in rubber compounding. In response, processing and dispersing aids and coupling agents are used during compounding.

In the art of making tires, it is desirable to employ rubber vulcanizates that demonstrate improved rolling resistance, wet skid resistance, and reduced hysteresis loss at certain temperatures. Factors believed to affect these properties include the degree of filler networking (particle agglomeration), the degree of polymer-filler interaction, the cross-link density of the rubber, and polymer free ends within the cross-linked rubber network.

Because precipitated silica has been increasingly used as reinforcing particulate filler in tires, there is a need to overcome the processing problems associated with silica fillers. There has been research into the addition of large amounts of water (approximately 50% of the weight of the silica) into silica containing rubber compounds. Although compounds having relatively large amounts of water added thereto may have lower mix temperatures, these high water levels reduce mixer capacity, require longer mix times, and more energy to remove the excess water. Additionally, there is a need to increase polymer-filler interaction in silica-filled tires, thereby improving rolling resistance, wear resistance, and wet skid resistance.

### SUMMARY OF THE INVENTION

In general the present invention provides a vulcanizable elastomeric composition comprising 100 parts by weight of elastomer, about 5 to about 100 parts by weight of silica per 100 parts said elastomer (phr), about 0.01 to about 25 weight percent, based upon the weight of the silica, of a silica-coupling agent, and about 0.01 to about 20 phr of free water.

The present invention also includes a process for preparing a cured elastomeric composition with increased dispersion of filler in the composition, comprising the steps of: (a) mixing polymer, silica, silica-coupling agent and free water to form an elastomeric composition; and (b) curing the elastomeric composition to form a rubber product.

The present invention further includes a pneumatic tire comprising a component produced from a vulcanized elastomeric compound, wherein the compound comprises 100 parts by weight of elastomer, about 5 to about 100 parts by weight of silica per 100 parts of elastomer (phr), about 0.01 to about 25 weight percent, based upon the weight of the silica, of a silica-coupling agent, and about 0.01 to about 20 phr of free water.

The term “free water” is used to describe the water added to the rubber composition, in addition to that already present in the silica or other compounding ingredients.

### DETAILED DESCRIPTION OF ILLUSTRATIVE EMBODIMENTS

The elastomeric compositions of the present invention contain elastomer, silica, silica-coupling agent, free water and optionally other rubber compounding ingredients.

Any conventionally used elastomer for rubber compounding is potentially available for the advantages of the present invention arising from the use of a catalytic amount of water in silica filled rubber compounds.

Non-limiting examples of elastomers potentially useful in the present invention include the following, individually as well as in combination, according to the desired final viscoelastic properties of the rubber compound: natural rubber, polyisoprene rubber, styrene butadiene rubber, polybutadiene rubber, butyl rubbers, halobutyl rubbers, ethylene propylene rubbers, crosslinked polyethylene, neoprenes, nitrile rubbers, chlorinated polyethylene rubbers, silicone rubbers, specialty heat & oil resistant rubbers, other specialty rubbers, and thermoplastic rubbers, as such terms are employed in The Vanderbilt Rubber Handbook, Thirteenth Edition, (1990).

Preferred elastomers include natural rubber, synthetic isoprene, styrene-butadiene copolymers, and butadiene rubber because of their common usage in the tire industry.

The ratios (often expressed as adding up to 100 parts) of such elastomer blends can range across the broadest possible range according to the need of final viscoelastic properties desired for the polymerized rubber compound. One skilled in the art, without undue experimentation, can readily determine which elastomers in what amount is appropriate for a resulting desired viscoelastic property range.

The elastomers of the present invention may further include a silica-interactive functional group. A silica-interactive functional group is a group or moiety that will react or interact with silica. The reaction or interaction of the silica-interactive functional group with the silica may occur via chemical reaction, resulting in an ionic or covalent bond between the functional group and the silica particle. Alternately, the interaction of the silica-interactive functional group with the silica may occur via through-space interaction (e.g., hydrogen bonding, van der Waals interaction, etc.). The interaction may be an attraction that creates a domain within the rubber matrix of the polymer. The interaction may be an affinity toward filler particles that is activated during or after processing of a vulcanized rubber formulation, e.g., during cure.

Useful functional groups include alkoxysilyl, amine, hydroxyl, polyalkylene glycol, epoxy, carboxylic acid, and anhydride groups, as well as polymeric metal salts of carboxylic acids.

An exemplary elastomer containing an alkoxysilyl functional group is represented by the formula 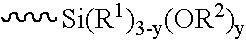
where [symbol] is an elastomeric polymer, each R¹ is independently a halogen or a monovalent organic group, each R² is independently a monovalent organic group, and y is an integer from 1 to 3. The halogen is chlorine, bromine, or iodine, preferably chlorine.

The monovalent organic groups are preferably hydrocarbyl groups such as, but not limited to alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of carbon atoms to form the group, up to 20 carbon atoms. These hydrocarbyl groups may contain heteroatoms such as, but not limited to, nitrogen, oxygen, silicon, sulfur, and phosphorus atoms. Preferably, R² has from 1 to about 4 carbon atoms.

In a preferred embodiment, the alkoxysilyl-functionalized elastomer is prepared by reacting a living polymer chain with a siloxane terminating agent. Preparation of living polymer is well-known. Anionically polymerized diene polymers and copolymers containing functional groups derived from siloxane terminating agents are further described in U.S. Pat. Nos. 6,008,295 and 6,228,908, incorporated herein by reference. Other polymers acceptable for use with the present invention may have side-chain functionalization.

Any siloxane compound that will react with the living terminal of a living polymer chain to form an alkoxysilyl-functionalized elastomer may be used. Useful siloxane compounds are represented by the formula
(R¹)_{4-z}Si(OR²)_{z}
where R¹ and R² are as described above, and z is an integer from 1 to 4. Suitable examples of siloxane terminating agents include tetraalkoxysilanes, alkylalkoxysilanes, arylalkoxysilanes, alkenylalkoxysilanes, and haloalkoxysilanes.

Examples of tetraalkoxysilane compounds include tetramethyl orthosilicate, tetraethyl orthosilicate, tetrapropyl orthosilicate, tetrabutyl orthosilicate, tetra(2-ethylhexyl) orthosilicate, tetraphenyl orthosilicate, tetratoluyloxysilane, and the like.

Examples of alkylalkoxysilane compounds include methyltrimethoxysilane, methyltriethoxysilane, methyltri-n-propoxysilane, methyltri-n-butoxysilane, methyltriphenoxysilane, ethyltrimethoxysilane, ethyltriethoxysilane, ethyltri-n-propoxysilane, ethyltri-n-butoxysilane, ethyltriphenoxysilane, dimethyldimethoxysilane, dimethyldiethoxysilane, dimethyldi-n-propoxysilane, dimethyldi-n-butoxysilane, dimethyldiphenoxysilane, diethyldimethoxysilane, diphenyldimethoxysilane, 3-glycidoxypropyltrimethoxysilane (GPMOS), γ-methacryloxy propyl trimethoxysilane and the like.

Examples of arylalkoxysilane compounds include phenyltrimethoxysilane, phenyltriethoxysilane, phenyltri-n-propoxysilane, phenyltri-n-butoxysilane, phenyltriphenoxysilane, and the like.

Examples of alkenylalkoxysilane compounds include vinyltrimethoxysilane, vinyltriethoxysilane, vinyltri-n-propoxysilane, vinyltri-n-butoxysilane, vinyltriphenoxysilane, allyltrimethoxysilane, octenyltrimethoxysilane, divinyldimethoxysilane, and the like.

Examples of haloalkoxysilane compounds include trimethoxychlorosilane, triethoxychlorosilane, tri-n-propoxychlorosilane, tri-n-butoxychlorosilane, triphenoxychlorosilane, dimethoxydichlorosilane, diethoxydichlorosilane, di-n-propoxydichlorosilane, diphenoxydichlorosilane, methoxytrichlorosilane, ethoxytrichlorosilane, n-propoxytrichlorosilane, phenoxytrichlorosilane, trimethoxybromosilane, triethoxybromosilane, tri-n-propoxybromosilane, triphenoxybromosilane, dimethoxydibromosilane, diethoxydibromosilane, di-n-propoxydibromosilane, diphenoxydibromosilane, methoxytribromosilane, ethoxytribromosilane, n-propoxytribromosilane, phenoxytribromosilane, trimethoxyiodosilane, triethoxyiodosilane, tri-n-propoxyiodosilane, triphenoxyiodosilane, dimethoxydiiodosilane, di-n-propoxydiiodosilane, diphenoxydiiodosilane, methoxytriiodosilane, ethoxytriiodosilane, n-propoxytriiodosilane, phenoxytriiodosilane, and the like.

Other useful silanes include bis-(trimethoxysilane)-ether, 3-mercaptopropyltriethoxysilane, 3-mercaptopropyltrimethoxysilane, 3,3′-bis (triethoxysilylpropyl)disulfide, Si-69 (bis-(3-triethoxysilylpropyl)tetrasulfide) and the like.

Preferred hydroalkyoxy silane terminating agents include tetraethyl orthosilicate.

Where the elastomer contains an amine group, the amine functional group is not particularly limited, and may be a primary, secondary or tertiary amine, cyclic or acyclic. Elastomers having cyclic amino substituents are known in the art, and are further described in U.S. Pat. Nos. 6,080,835, 5,786,441, 6,025,450, and 6,046,288, which are incorporated herein by reference.

An elastomer having a silica-interactive group may include epoxidized rubber. Epoxidized rubber is a modified rubber where some of the rubber's unsaturation is replaced by epoxide groups. Epoxidized rubber is further described in co-pending U.S. application Ser. No. 10/269,445, which is incorporated herein by reference.

Elastomers having carboxylic acid, and anhydride groups, and polymeric metal salts of unsaturated carboxylic acids are further described in co-pending application no. PCT/US02/10621, which is incorporated herein by reference.

The elastomeric compositions of the invention are compounded with silica, or a mixture of silica and carbon black.

Examples of suitable silica filler include, but are not limited to, precipitated amorphous silica, wet silica (hydrated silicic acid), dry silica (anhydrous silicic acid), fumed silica, calcium silicate, and the like. Other suitable fillers include aluminum silicate, magnesium silicate, and the like. One embodiment of the present invention, the surface area of the silicas comprises about 32 m²/g to about 400 m²/g, with the range of about 100 m²/g to about 250 m²/g being preferred, and the range of about 150 m²/g to about 220 m²/g being most preferred. However, this invention is not limited to silica having any particular surface area. The pH of the silica filler is generally about 5.5 to about 7 or slightly over, preferably about 5.5 to about 6.8. The moisture content of the commercially available silica fillers is generally less than about 10% by weight of the silica, preferably less than 8% of the total weight of the silica, and most preferably from about 4 to about 7% of the total weight of the silica. The moisture content of the silica is determined by weight percent as the weight difference after 2 hours in a 105° C. oven.

Silica can be employed in the amount of about 5 to about 100 parts by weight per hundred parts of the elastomer (phr), preferably in an amount of about five to about 80 phr and, more preferably, in an amount of about 30 to about 80 phr. The useful upper range is limited by the high viscosity imparted by fillers of this type. Commercially available silicas include Hi-Sil™ 215, Hi-Sil™ 233, Hi-Sil™ 255LD, and Hi-Sil™ 190 (PPG Industries; Pittsburgh, Pa.), Zeosil™ 1165 MP and 175GRPlus (Rhodia, Cranbury, N.J.), Vulkasil™ S/kg (LANXESS Corp., Akron, Ohio), Ultrasil™ VN2, VN3 (Degussa, Parsippany, N.J.), and HuberSil™ 8745 (Huber Engineered Materials, Atlanta, Ga.).

In addition to silica, optionally the rubber compound may also contain all forms of carbon black. The carbon black can be present in amounts ranging from about 0 to about 80 phr, with about five to about 60 phr being preferred. The carbon black can include any of the commonly available, commercially-produced carbon blacks, but those having a surface area (EMSA) of at least about 20 m²/g and, more preferably, at least about 35 m²/g up to about 200 m²/g or higher are preferred. Surface area values used in this application are determined by ASTM D-1765 using the cetyltrimethyl-ammonium bromide (CTAB) technique.

Among the useful carbon blacks are furnace black, channel blacks and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks.

A mixture of two or more of the above blacks can be used in preparing the carbon black products of the invention. Preferred are SAF, HAF or GPF type carbon blacks. The carbon blacks utilized in the preparation of the vulcanizable elastomeric compositions of the invention can be in pelletized form or an unpelletized flocculent mass.

When both silica and carbon black are employed in combination as the reinforcing filler, they are often used in a silica-carbon black ratio of about 4:1 to about 1:10.

Other fillers that may be used include aluminum hydroxide, magnesium hydroxide, clays (hydrated aluminum silicates), and starch.

Suitable silica coupling agents include bifunctional silica coupling agents having a moiety (e.g., a silyl group) that will react or interact with the silica filler, and a moiety (e.g., a mercapto, amino, vinyl, epoxy or sulfur group) that will react or interact with the elastomer. Examples of silica coupling agents are bis(trialkoxysilylorgano) polysulfides and mercaptosilanes.

Bis(trialkoxysilylorgano)polysulfides include bis(trialkoxysilylorgano) disulfides and bis(trialkoxysilylorgano)tetrasulfides. Examples of bis(trialkoxysilylorgano)disulfides include 3,3′-bis(triethoxysilylpropyl) disulfide, 3,3′-bis(trimethoxysilylpropyl)disulfide, 3,3′-bis(tributoxysilylpropyl)disulfide, 3,3′-bis(tri-t-butoxysilylpropyl)disulfide, 3,3′-bis (trihexoxysilylpropyl)disulfide, 2,2′-bis(dimethylmethoxysilylethyl)disulfide, 3,3′-bis(diphenylcyclohexoxysilylpropyl)disulfide, 3,3′-bis(ethyl-di-sec-butoxysilylpropyl)disulfide, 3,3′-bis(propyldiethoxysilylpropyl)disulfide, 12,12′-bis(triisopropoxysilylpropyl)disulfide, 3,3′-bis(dimethoxyphenylsilyl-2-methylpropyl)disulfide, and mixtures thereof.

Examples of bis(trialkoxysilylorgano)tetrasulfide silica coupling agents include bis(3-triethoxysilylpropyl)tetrasulfide, bis(2-triethoxysilylethyl) tetrasufide, bis(3-trimethoxysilylpropyl)tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Bis(3-triethoxysilylpropyl)tetrasulfide is sold commercially as Si69 by Degussa.

Although the bis(trialkoxysilylorgano)tetrasulfides having methoxysilane groups can be used, ethoxysilanes are preferred, because ethyl alcohol, rather than methyl alcohol, will be released when the alkoxysilane portion of the coupling agent reacts with the surface of the silica particle.

Suitable mercaptosilanes include compounds represented by the formula 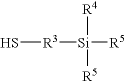
where R³ is a divalent organic group, R⁴ is a halogen atom or an alkoxy group, and each R⁵ is independently a halogen, an alkoxy group, or a monovalent organic group. The monovalent organic group is preferably as described above. The halogen is chlorine, bromine, or iodine, preferably chlorine. The alkoxy group preferably has from 1 to 3 carbon atoms.

The divalent organic group is preferably a hydrocarbylene group or substituted hydrocarbylene group such as, but not limited to, alkylene, cycloalkylene, substituted alkylene, substituted cycloalkylene, alkenylene, cycloalkenylene, substituted alkenylene, substituted cycloalkenylene, arylene, and substituted arylene groups, with each group preferably containing from 1 carbon atom, or the appropriate minimum number of carbon atoms to form the group, up to about 20 carbon atoms. The divalent organic group is preferably an alkylene group containing from 1 to about 4 carbon atoms.

Examples of mercaptosilanes include 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Silica coupling agents are further described in U.S. Pat. Nos. 3,842,111, 3,873,489, 3,978,103, 3,997,581, 4,002,594, 5,580,919, 5,583,245, 5,663,396, 5,674,932, 5,684,171, 5,684,172 and 5,696,197, 6,608,145, and 6,667,362, which are incorporated herein by reference. Preferred silica coupling agents include bis(3-triethoxysilylpropyl)disulfide (Disulfane). If desired, the silica coupling agent may be added in an amount of from about 0.01 to about 25 weight percent, based upon the weight of the silica, preferably from about 0.5 to about 15 weight percent, and more preferably from about 1 to about 10 weight percent, based upon the weight of silica.

Water may be used as catalyst to enhance the reaction between the silica and the coupling agent. The term “free water” is used to describe the water added to the rubber composition, in addition to that already present in the silica or other compounding ingredients. No special treatment of the water is necessary, and the use of tap water is acceptable however, distilled and/or deionized water is preferable. The water may be added to the rubber composition as a liquid, solid, gas or as a pre-blend on a carrier. Suitable carriers may include silica, carbon black and other non-reinforcing fillers.

Water, as a liquid is preferably added during the earliest mixing step wherein reinforcing filler and coupling agent are present. The amount of water is not particularly limited, but is preferably from about 0.01 to about 20 parts per hundred elastomer (phr), more preferably from about 0.20 to about 5 phr, and even more preferably from about 1 to about 3 phr.

In one embodiment, the catalyst is premixed with a carrier. Suitable carriers include any material that is not deleterious to the vulcanizable elastomeric composition. Examples include stearic acid, mineral oil, plastics, wax and organic solvents. Preferably, the premix contains from about 1 part by weight catalyst per 3 parts by weight carrier to about 1 part by weight catalyst per 1 part by weight carrier, with the proviso that, where the carrier is a polar substance, the amount of carrier does not exceed about 2 parts by weight per hundred parts rubber.

Additional optional ingredients include silica processing aids, which may be used to aid in, for example, dispersing and/or shielding the silica particles, preventing agglomeration, reducing viscosity, and increasing scorch time. Generally, silica processing aids do not substantially interact with the rubber molecules. Silica processing aids include monofunctional compounds that chemically react with surface silanol groups on the silica particles, but are not reactive with the elastomer. Silica processing aids also include shielding agents that physically shield the silanol groups, to prevent reagglomeration or flocculation of the silica particles.

Suitable silica processing aids include glycols, alkyl alkoxysilanes, fatty acid esters of hydrogenated and non-hydrogenated C₅ and C₆ sugars, polyoxethylene derivatives of the fatty acid esters, mineral fillers, and non-mineral fillers. These silica dispersing agents can be used to replace all or part of the bifunctional silica coupling agents, while improving the processability of silica-filled rubber compounds by reducing the compound viscosity, increasing the scorch time, and reducing silica reagglomeration. Specific examples of glycols include diethylene glycol or polyethylene glycol.

Alkyl alkoxysilanes suitable for use as silica processing aids in the invention compounds have the formula
R⁶ₚSi(OR²)₄₋ₚ
where each R² is independently as described above, each R⁶ is independently a monovalent organic group, and p is an integer from 1 to 3, with the proviso that at least one R⁶ is an alkyl group. Preferably, p is 1.

Examples of alkyl alkoxysilanes include octyl triethoxysilane, octyl trimethoxysilane, trimethyl ethoxysilane, cyclohexyl triethoxysilane, isobutyl triethoxysilane, ethyl trimethoxysilane, cyclohexyl tributoxysilane, dimethyl diethoxysilane, methyl triethoxysilane, propyl triethoxysilane, hexyl triethoxysilane, heptyl triethoxysilane, nonyl triethoxysilane, octadecyl triethoxysilane, methyloctyl diethoxysilane, dimethyl dimethoxysilane, methyl trimethoxysilane, propyl trimethoxysilane, hexyl trimethoxysilane, heptyl trimethoxysilane, nonyl trimethoxysilane, octadecyl trimethoxysilane, methyloctyl dimethoxysilane. Preferably, the alkyl alkoxysilane is a triethoxysilane. More preferably, the alkyl alkoxysilane is selected from at least one of n-octyl triethoxysilane, n-hexadecyl triethoxysilane and n-octadecyl triethoxysilane.

The alkyl alkoxysilane can be present in the compound in an amount of about 0.1% to about 25% by weight, preferably about 0.1% to about 15% by weight, based on the weight of the silica.

Examples of fatty acid esters of hydrogenated and non-hydrogenated C₅ and C₆ sugars (e.g., sorbose, mannose, and arabinose) that are useful as silica processing aids include the sorbitan oleates, such as sorbitan monooleate, dioleate, trioleate and sesquioleate, as well as sorbitan esters of laurate, palmitate and stearate fatty acids. Fatty acid esters of hydrogenated and non-hydrogenated C₅ and C₆ sugars are commercially available from ICI Specialty Chemicals (Wilmington, Del.) under the trade name SPAN®. Representative products include SPAN® 60 (sorbitan stearate), SPAN® 80 (sorbitan oleate), and SPAN® 85 (sorbitan trioleate). Other commercially available fatty acid esters of sorbitan include the sorbitan monooleates known as Alkamul® SMO, Capmul® O, Glycomul® O, Arlacel® 80, Emsorb® 2500, and S-Maz® 80. When used with bis(trialkoxysilylorgano) polysulfide silica coupling agents, these fatty acid esters are preferably present in an amount of from about 0.1% to about 25% by weight based on the weight of the silica, more preferably from about 0.5% to about 20% by weight of silica, even more preferably from about 1% to about 15% by weight based on the weight of silica.

Examples of polyoxyethylene derivatives of fatty acid esters of hydrogenated and non-hydrogenated C₅ and C₆ sugars include polysorbates and polyoxyethylene sorbitan esters, which are analogous to the fatty acid esters of hydrogenated and non-hydrogenated sugars noted above except that ethylene oxide groups are placed on each of the hydroxyl groups. Commercially available polyoxyethylene derivatives of sorbitan include POE® (20) sorbitan monooleate, Polysorbate® 80, Tween® 80, Emsorb® 6900, Liposorb® 0-20, and T-Maz® 80. The Tween® products are commercially available from ICI Specialty Chemicals. Generally, a useful amount of these optional silica dispersing aids is from about 0.1% to about 25% by weight based on the weight of the silica, preferably from about 0.5% to about 20% by weight, more preferably from about 1% to about 15% by weight based on the weight of the silica. Preferred silica processing aids include n-octyltriethoxysilane.

Certain additional fillers can be utilized as processing aids, including mineral fillers, such as clay (hydrous aluminum silicate), talc (hydrous magnesium silicate), aluminum hydrate [Al(OH)₃] and mica, as well as non-mineral fillers such as urea and sodium sulfate. Preferred micas principally contain alumina and silica. When used, these fillers can be present in the amount of from about 0.5 to about 40 parts per phr, preferably in an amount of about 1 to about 20 phr, more preferably in an amount of about 1 to about 10 phr. These additional fillers can also be used as non-reinforcing fillers to support any of the silica dispersing aids and silica coupling agents described above. Silica processing aids are further described in U.S. Pat. Nos. 6,342,552, 6,525,118 and 6,608,145, which are incorporated herein by reference.

Other optional ingredients may also be selected from a multitude of rubber curing agents, including sulfur or peroxide-based curing systems. Curing agents are described in Kirk-Othmer, Encyclopedia of Chemical Technology, Vol. 20, pp. 365-468, (3^{rd} Ed. 1982), particularly Vulcanization Agents and Auxiliary Materials, 390-402, and A. Y. Coran, Vulcanization in Encyclopedia of Polymer Science and Engineering, (2^{nd} Ed. 1989), which are incorporated herein by reference. Vulcanizing agents may be used alone or in combination.

Additionally, accelerators may be used in conjunction with vulcanizing agents. Examples of cure accelerators include thiazoles, dithiocarbamates, dithiophosphates, guanidines, sulfenamides, sulfenimides, and thiurams. Specific examples include 2-mercaptobenzothiazol, dibenzothiazyl disulfide, N-cyclohexyl-2-benzothiazyl-sulfenamide (CBS), N-tert-butyl-2-benzothiazyl sulfenamide (TBBS), and 1,3-diphenylguanidine. If used, the amount of accelerator is preferably from about 0.1 to about 5 phr, more preferably from about 0.2 to about 3 phr. Zinc oxide also may be added to the rubber composition, in an amount of from about 1 to about 5 phr.

Other ingredients that may be employed in the rubber compound include oils, waxes, scorch inhibiting agents, tackifying resins, reinforcing resins, fatty acids such as stearic acid, peptizers, and one or more additional rubbers. These ingredients are known in the art, and may be added in appropriate amounts based on the desired physical and mechanical properties of the rubber compound.

Rubber compounding techniques and the additives employed therein are further described in Stephens, The Compounding and Vulcanization of Rubber, in Rubber Technology (2^{nd} Ed. 1973). The mixing conditions and procedures applicable to silica-filled tire formulations are also well known as described in U.S. Pat. Nos. 5,227,425, 5,719,207, 5,717,022, as well as European Patent No. 890,606, all of which are incorporated herein by reference.

Where the vulcanizable elastomeric compositions are employed in the manufacture of tires, these compositions can be processed into tire components according to ordinary tire manufacturing techniques including standard rubber shaping, molding and curing techniques. The rubber compositions of the present invention are particularly useful in preparing tire components such as treads, subtreads, black sidewalls, body ply skins, bead filler, and the like. The construction and curing of the tire are not significantly affected by the practice of this invention. Pneumatic tires can be made as discussed in U.S. Pat. Nos. 5,866,171, 5,876,527, 5,931,211, and 5,971,046, which are incorporated herein by reference.

In certain embodiments, the tire compositions of this invention advantageously have improved rubber compound reinforcement, which is believed to be caused by increased polymer-filler interaction, which results in improved rolling resistance, reduced wear, and improved wet traction. Excellent polymer processability is maintained. These tire compositions can be readily prepared according the methods described herein.

In order to demonstrate the practice of the present invention, the following examples have been prepared and tested. The examples should not, however, be viewed as limiting the scope of the invention. The claims will serve to define the invention.

### GENERAL EXPERIMENTAL MATERIALS EXAMPLES

In these Examples, an elastomeric composition containing silica filler, silica-coupling agent and free water was compared to a compound without additional water.

### Control Example A and Experimental Example 1

Control Example A (Comp. A) was representative of a carbon black and silica filled elastomeric composition. Experimental Example 1 (Exp. 1) was a modified version of this compound, additionally containing 1.14 phr of water.

Each of these examples were mixed in three mix stages using a 1300 g Banbury, at an agitation speed of 60 rpm. For the first non-productive mix stage, the ingredients were mixed for approximately 150 seconds to a drop temperature of about 155° C. The resulting rubber composition was then reintroduced into the banbury, and silane and water were mixed therewith, to a drop temperature of about 145° C. In the final, productive mixing stage, sulfur curatives, accelerators, and antioxidants were added, and mixed until the temperature of the rubber reached about 105° C.° C.

Table 1 contains the formulations for each of Control Example A and Experimental Example 1.

TABLE 1

| | Cont. A | Exp. 1 |
|---|---|---|
| Materials | (phr) | (phr) |
| Masterbatch | | |
| Styrene-Butadiene Rubber¹ | 100.00 | 100.00 |
| Silica | 35.00 | 35.00 |
| Non-silica fillers | 50.00 | 50.00 |
| Aromatic Process Oil | 29.16 | 29.16 |
| Wax | 1.50 | 1.50 |
| Remill | | |
| Disulfide Silane | 3.15 | 3.15 |
| Water | 0 | 1.14 |
| Final | | |
| Zinc Oxide | 1.70 | 1.70 |
| Stearic Acid | 0.50 | 0.50 |
| Antidegradant | 0.95 | 0.95 |
| Accelerators | 5.50 | 5.50 |
| Sulfur | 2.30 | 2.30 |

¹Tin coupled, 20% styrene, 58% vinyl

The processing of compounds Cont. A and Exp. 1 was evaluated by examining the compound Mooney and scorch data (Table 2). Mooney viscosity measurements were conducted at 130° C. using a large rotor. The Mooney viscosity was recorded as the torque when rotor has rotated for 4 minutes. The sample is preheated at 130° C. for 1 minute before the rotor starts. T₅ is the time in seconds required to increase 5 Mooney units during the Mooney-scorch measurement. It is used as an index to predict how fast the compound viscosity will arise during processing.

TABLE 2

| | Ml1 + 4 | T5 scorch at |
|---|---|---|
| Compound | at 130° C. | 13O° C. (sec) |
| Cont. A | 50.1 | 826 |
| Exp. 1 | 50.8 | 865 |

As can be seen by the data contained in Table 2, the predicted processing properties of the tread compound are not significantly affected by the addition of water into the composition.

The concentration of ethoxy silane (EtOSi) in the unvulcanized rubber after compounding was used as a predictor of the degree of silica hydrophobation. Lower levels of EtOSi correspond to a higher degree of silica hydrophobation, and potentially, the higher the number of links between polymer and filler after curing. Quantitative determination of ethanol was used as a measure of the concentration of EtOSi left unreacted in the uncured stocks. The EtOSi in the stock was measured by treating a sample with a siloxane hydrolysis reagent composed of 0.2N toluenesulfonic acid, 0.24N water, 15% n-butanol in toluene. This reagent was then allowed to react with the residual EtOSi, thereby releasing a stoiciometric amount of ethanol that was measured by a headspace/gas chromatographic technique. This technique is further described by Lin et al. in Rubber Chemistry and Technology, Vol. 75, p. 215 (2002). The results of this evaluation are shown in Table 3.

TABLE 3

| | EtOSi before | EtOSi after | |
|---|---|---|---|
| | compounding, | compounding, | % unreacted |
| Compound | wt % | wt. % | EtOSi |
| Cont. A | 1.37 | 0.445 | 32.5 |
| Exp. 1 | 1.37 | 0.386 | 28.2 |

The degree of reinforcement of the rubber compounds was evaluated by examining the filler flocculation behavior as well as the bound rubber content. Due to the increased polymer-filler interaction associated therewith, filler flocculation can be considered indirectly related to the degree of reinforcement of a rubber compound. This relationship is discussed by Lin et al. in Rubber Chemistry and Technology, Vol. 75, pp. 215-275 (2002), Rubber Chemistry and Technology, Vol. 75, pp. 865-891(2002) and Rubber Chemistry and Technology, Vol. 77, p. 90-114 (2004) The filler flocculation behavior of each compound was evaluated by examining the Payne Effect data (δ(ΔG′)) in the rubber compound prior to the addition of curatives and after thermal annealing, where δ(ΔG′) is defined as:
δ(ΔG′)=ΔG′ with thermal annealing−ΔG′ without thermal annealing

The G′ was measured on Control A and Experimental 1 stocks, prior to the addition of curing curing agents by strain sweep experiment using RPA 2000 Rubber Process Analyzer (Alpha Technologies) at 50° C. and 0.1 Hz by varying the strain from 0.25% to 1000%. Rheological data such as storage modulus (G′) and loss modulus (G″), strain, shear rate, viscosity, and torque were measured. Thermal annealing at 171° C. for 15 minutes simulated the heat history normally encountered during vulcanization. The annealed compounds were then cooled to 40° C. for thirty minutes before starting the strain sweep experiment using the RPA 2000. The results of this evaluation are shown in Table 4.

TABLE 4

| Compound ID | δ(ΔG′) kPa |
|---|---|
| Cont. A | 2568 |
| Exp. 1 | 2326 |

The relationship between ΔG′ and filler networking is well understood. The decrease in δ(ΔG′) exhibited by Expermental Compound 1 is indicative of a decrease in filler flocculation when compared with Control Compound A, and therefore suggests a higher degree of silanization reaction between silane and filler, and thereafter, polymer-filler interaction.

Bound rubber, a measure of the percentage of rubber bound, through some interaction, to the filler, was determined by solvent extraction with toluene at room temperature. More specifically, a test specimen of each uncured rubber formulation was placed in toluene for three days. The solvent was removed and the residue was dried and weighed. The percentage of bound rubber was then determined according to the formula
% bound rubber=(100(W_{d}−F))/R

where W_{d} is the weight of the dried residue, F is the weight of the filler and any other solvent insoluble matter in the original sample, and R is the weight of the rubber in the original sample. The results of the % bound rubber determination are found in Table 5.

TABLE 5

| Compound ID | % Bound Rubber |
|---|---|
| Cont. A | 29.6 |
| Exp. 1 | 31.3 |

The tensile mechanical properties of Cont. A and Exp. 1 are listed in Table 6. The tensile mechanical properties were measured using the standard procedure described in ASMT-D 412 at both 25° C. and 100° C. The tensile test specimens were dumbbell shaped, having a thickness of 1.9 mm. A specific gauge length of 25.4 mm was used for the tensile test.

The tear strength and elongation at break (E_{b}) of the rubber compounds measured at both 100° C. amd 171° C. are also listed in Table 6. The tear strengths of the vulcanized stocks were measured following the procedure found in ASTM-D 624. Test specimens were nicked round rings measuring 0.25 inches in width, 0.10 inches in thickness and 44 mm and 57.5 mm for inside and outside diameters, respectively. The specimens were tested at the specific gauge length of 1.750 inches.

The dynamic viscoelastic properties of the cured stocks were determined by using a Rheometrics Dynamic Analyzer (RDA). These results are found in Table 6. The tan δ at 0° C. and 50° C., taken at 2% strain, were obtained from strain sweep experiments conducted at a frequency of 3.14 rad/sec strain sweeping from 0.25% to 14.75%.

The Zwick Rebound Test is a dynamic test that measures rebound resilience. Rebound resilience is typically defined as the ratio of mechanical energies before and after impact. Samples were tested according to ASTM D1054-91(2000), the results of which are found in Table 6. Sample specimens were milled and cured according to ASTM D1054, using the mold specified. The cured sample was coated with talc and conditioned in an oven for about one hour at the recommended temperature. The conditioned sample was placed into a Zwick type rebound tester, a pendulum was swung against the sample, and the angle at which the pendulum bounced back was measured. Percent rebound is calculated according to the equation specified in ASTM D1054.

The wear resistance of the test samples were evaluated using the Lambourn Abrasion test. Test specimens are rubber wheels of about 48 mm in outside diameter, about 22 mm in inside diameter and about 4.8 mm in thickness. The test specimens were placed on an axle and run at a slip ratio of 65% against a driven abrasive surface for approximately 75 seconds. The abrading surface used was 120 grit 3M-ite. A load of about 2.5 kg was applied to the rubber wheel during testing.

A linear, least squares curve-fit is applied to the weight loss data as a function of time. The slope of the line is the abrasion rate. The reported abrasion index is one-hundred multiplied by the control compound abrasion rate divided by the experimental compound abrasion rate. Thus, an abrasion index greater than 100 indicates that the experimental compound is better (abrades at a lower rate) than the control compound. The Lambourn abrasion for Cont. A and Exp. 1 rubber compounds is listed in Table 6.

TABLE 6

| Sample No. | Cont. A | Exp. 1 |
|---|---|---|
| 50% Modulus 25° C. (MPa) | 1.39 | 1.28 |
| Tensile at Break @ 25° C. (MPa) | 15.71 | 17.62 |
| Elongation at Break @ 25° C. | 398 | 466 |
| Toughness @ 25° C. (MPa) | 27.91 | 35.15 |
| 50% Modulus 100° C. (MPa) | 1.14 | 1.07 |
| Tensile at Break @ 100° C. (MPa) | 6.30 | 7.37 |
| Elongation at Break @ 100° C. | 225 | 287 |
| Toughness @ 100° C. (MPa) | 6.55 | 9.68 |
| Tear Strength @ 100° C. (kN/m) | 17.38 | 28.24 |
| Elongation at Break @ 100° C. (%) | 190 | 352 |
| Tear Strength @ 171° C. (kN/m) | 4.73 | 8.31 |
| Elongation at Break @ 171° C. (%) | 61 | 107 |
| tan δ @ 0° C. | 0.3887 | 0.3812 |
| tan δ @ 50° C. | 0.2205 | 0.2064 |
| Zwick Rebound (50° C.) | 46.6 | 47.4 |
| Abrasion Index | 100 | 116 |

Various modifications and alterations that do not depart from the scope and spirit of this invention will become apparent to those skilled in the art. This invention is not to be duly limited to the illustrative embodiments set forth herein.

1. A vulcanizable elastomer composition comprising:
100 parts by weight of elastomer;
about 5 to about 100 parts by weight of silica per 100 parts of elastomer (phr);
about 0.01 to about 25 weight percent, based upon the weight of the silica, of a silica-coupling agent; and
about 0.01 to about 20 phr of free water.

2. The composition of claim 1, further comprising about 5 to about 60 phr of carbon black.

3. The composition of claim 2, wherein the ratio of silica to carbon black is about 4:1 to about 1:10.

4. The composition of claim 1, wherein the elastomer is selected from the group consisting of natural rubber, isoprene, styrene-butadiene, styrene-isoprene-butadiene, butadiene, butadiene-isoprene, ethylene-propylene, nitrile, acrylate-butadiene, chloro-isobutene-isoprene, nitrile-butadiene, nitrile-chloroprene, styrene-chloroprene, styrene-isoprene rubbers, and combinations thereof.

5. The composition of claim 4, wherein the elastomer is functionalized with a silica-interactive functional group.

6. The composition of claim 5, wherein the silica-interactive functional group is selected from alkoxysilyl, amine, hydroxyl, polyalkylene glycol, epoxy, carboxylic acid, and anhydride groups, as well as polymeric metal salts of carboxylic acids.

7. The composition of claim 1, wherein the silica has a moisture content of about 8% or less of the total weight of the silica.

8. The compositiona of claim 7, wherein the silica has a moisture content of about 4 to about 7 weight percent.

9. The composition of claim 1 wherein the amount of free water is about 0.20 to about 5 phr.

10. The composition of claim 1, further comprising a silica processing aid.

11. A process for preparing a cured elastomeric composition, comprising the steps of:
(a) mixing elastomer, silica, silica-coupling agent and free water to form a compound; and
(b) curing the compound to form a product.

12. The process of claim 10, wherein the free water is combined with the silica prior to mixing with the elastomer and coupling agent.

13. The process of claim 10, wherein the elastomer contains a silica-interactive functional group.

14. The process of claim 12, wherein the silica-interactive functional group is selected from alkoxysilyl, amine, hydroxyl, polyalkylene glycol, epoxy, carboxylic acid, and anhydride groups, as well as polymeric metal salts of carboxylic acids.

15. The process of claim 11, wherein the silica has a moisture content of about 8% or less of the total weight of the silica.

16. The process of claim 14, wherein step (a) comprises mixing:
100 parts by weight of elastomer;
about 5 to about 100 parts by weight of silica per 100 parts of elastomer (phr);
about 0.01 to about 25 weight percent, based upon the weight of the silica, of a silica-coupling agent; and
about 0.01 to about 20 phr of free water

17. A pneumatic tire comprising a component produced from a vulcanized elastomeric compound, wherein the compound comprises:
100 parts by weight of elastomer;
about 5 to about 100 parts by weight of silica per 100 parts of elastomer (phr);
about 0.01 to about 25 weight percent, based upon the weight of the silica, of a silica-coupling agent; and
about 0.01 to about 20 phr of free water.

18. The tire of claim 16, wherein the compound further comprises about 5 to about 60 phr of carbon black.

19. (canceled)

19. The tire of claim 16, wherein the silica has a moisture content of about 8% or less of the total weight of the silica.

20. The tire of claim 16, wherein the amount of free water is about 0.20 to about 5 phr.
